(19) United States
(12) Patent Application Publication
(10) Pub. No.: US 2020/0210691 A1
(43) Pub. Date: Jul. 2, 2020

(54) METHOD AND DEVICE FOR TRANSMITTING INFORMATION FROM A FIRST ROAD USER TO A SECOND ROAD USER AND FOR RECEIVING INFORMATION THAT HAS BEEN TRANSMITTED FROM A FIRST ROAD USER TO A SECOND ROAD USER

(71) Applicant: VOLKSWAGEN AKTIENGESELLSCHAFT, Wolfsburg (DE)

(72) Inventors: Sebastian GEHRLING, Essen (DE); Jens KAMPERMANN, Haan (DE); Sarah STRYGULEC, Wuppertal (DE); Sven KLOMP, Uetze / Dollbergen (DE); Jessica APFEL, Paderborn (DE); Sandra JÜRGENSMEIER, Delbrück (DE); Wolfgang THEIMER, Bochum (DE); Ernst ZIELINSKI, Bochum (DE); Esref KÖSE, Bochum (DE); Ahmed ALI, Bochum (DE)

(21) Appl. No.: 16/645,251

(22) PCT Filed: Aug. 29, 2018
(86) PCT No.: PCT/EP2018/073284

§ 371 Date: Mar. 6, 2020

(30) Foreign Application Priority Data
Sep. 21, 2017 (DE) 10 2017 216 737.8

(51) Int. Cl. G06K 9/00; B60W 60/00; H04W 4/46

(52) U.S. Cl. CPC G06K 9/00355; G06K 9/00791; G06K 9/00832; H04W 4/46; B60W 60/0015; B60W 60/0025; B60W 60/0011

(57) ABSTRACT

A method for sending information for a gesture communication between two road users, wherein a first road user is in an ego transportation vehicle and a second road user is in another transportation vehicle in the vehicle surroundings of the ego transportation vehicle. The method includes detecting the hand and/or finger of the first road user in the ego transportation vehicle by sensor; ascertaining a gesture that the first road user makes in the ego transportation vehicle with his hand and/or finger; evaluating the ascertained gesture to determine whether the ascertained gesture is a gesture for gesture communication and is directed at a second road user in another transportation vehicle; and sending a signal containing information about the ascertained gesture for gesture communication to the second road user by the first road user in response to the ascertained gesture being directed at a second road user in another transportation vehicle.

### PRIORITY CLAIM

This patent application is a U.S. National Phase of International Patent Application No. PCT/EP2018/073284, filed 29 Aug. 2018, which claims priority to German Patent Application No. 10 2017 216 737.8, filed 21 Sep. 2017, the disclosures of which are incorporated herein by reference in their entireties.

### SUMMARY

Illustrative embodiments relate to a method for sending information from a first road user to a second road user and a method for receiving information that has been sent from a first road user to a second road user. Illustrative embodiments also relate to an apparatus for performing the method and a transportation vehicle that is configured to perform such a method or has such an apparatus.

### BRIEF DESCRIPTION OF THE DRAWINGS

Disclosed embodiments will be explained in more detail below with reference to the drawings, in which:

FIG. 1 schematically shows a flowchart for a disclosed method for sending information from a first road user to a second road user;

FIG. 2 schematically shows a flowchart for a disclosed method for receiving information that has been sent to a second road user by a first road user;

FIG. 3 schematically shows a transportation vehicle having an exemplary apparatus; and

FIG. 4 shows an example of a traffic situation in which gesture information is sent from an ego transportation vehicle to another transportation vehicle and is output there.

### DETAILED DESCRIPTION

In unclear traffic situations or in hazard situations, road users frequently communicate using visual signals. As such, the driver of a transportation vehicle can send a light signal to other road users by flashing his headlights, turning on his indicators or operating the hazard warning lights. However, it is also very common to exchange information with other road users by gestures, such as, arm or hand signals.

Visual signals are not always picked up and understood by the desired recipient. If they are missed, this can lead to misunderstandings and can hamper the flow of traffic or even cause accidents. At present, whether a visual signal has been received and picked up can be verified among the road users only by visual contact, however. If visual contact cannot be made, it is merely possible to attempt to draw attention to oneself by further signals such as sounding the horn or flashing the headlights. Since these signals are not focused, there is, however, no assurance that the correct road user will know that he is being addressed. Furthermore, this can lead to confusion among other road users who are not meant to be addressed. It is thus desirable to develop a way of optimizing the communication of road users among one another in road traffic.

DE 10 2015 207 337 A1 discloses a method in which two occupants of two different transportation vehicles can communicate interactively for the purpose of conversation. In this case, the two occupants each wear smart glasses, a sensor system being used to detect an interaction by one occupant and to link it to an interaction by the other occupant, and/or the detected interaction being conveyed to the smart glasses of the other occupant. As such, for example, the two occupants can signal jointly even though they are in different transportation vehicles. Although this method allows a communication between different road users, it requires smart glasses to be present in each of the two transportation vehicles. Further, the method is also not suitable for detecting a visual signal, such as, a gesture, and passing on the detected gesture.

Disclosed embodiments provide an improved method and an improved apparatus for communication between road users.

This is achieved by a method and by a corresponding apparatus.

The disclosed method for sending information from a first road user to a second road user involves the hand or at least one finger of a first road user being detected by a sensor. A gesture that the first road user makes with his hand or at least one finger is ascertained. The ascertained gesture is evaluated to determine whether it is directed at a second road user. A signal containing information about the ascertained gesture is sent to the second road user by the first road user if the ascertained gesture is directed at a second road user.

In this way, the disclosed method for sending information allows a road user, such as, for example, the driver of a transportation vehicle, to convey an intention to interact, information and warnings to another road user in a focused manner on the basis of gesture inputs.

The disclosed method for receiving information that has been sent to a second road user by a first road user involves a second road user receiving a signal transmitted by a first road user. In this instance, the transmitted signal contains information about a gesture made by the first road user with his hand or at least one finger. The received signal is evaluated to determine whether the gesture made by the first road user has been directed by him at the receiving second road user. Information about the gesture made by the first road user to the second road user is output if the gesture has been directed at the second road user.

Thus, the disclosed method for receiving information involves a road user being advised on an intention to interact, information and warnings that another road user directs at him by gestures, so that this information is prevented from being missed or not picked up.

According to at least one disclosed embodiment, the first road user is in an ego transportation vehicle and the second road user is in another transportation vehicle in the transportation vehicle surroundings of the ego transportation vehicle.

Optionally, the ego transportation vehicle in this instance additionally ascertains a direction and/or position statement and transmits it to the other transportation vehicle.

The other transportation vehicle ascertains from the transmitted direction and/or position statement whether the gesture has been directed at the second road user by the first road user.

Furthermore, the direction statement is ascertained by detecting the line of vision of the transportation vehicle occupant of the ego transportation vehicle.

Finally, it is beneficial if the position statement is ascertained from a GPS signal received by the ego transportation vehicle.

Accordingly, an exemplary apparatus for sending information from a first road user to a second road user comprises a detection unit that detects the hand or at least one finger of a first road user by sensor. Data are supplied to an evaluation and control unit by the detection unit. The evaluation and control unit takes the data of the detection unit as a basis for ascertaining a gesture that the first road user makes with his hand or at least one finger and evaluates the ascertained gesture to determine whether the ascertained gesture has been directed at a second road user. Information about the ascertained gesture is supplied to a communication unit by the evaluation and control unit if the ascertained gesture is directed at a second road user. The communication unit sends a signal containing information about the ascertained gesture to an apparatus of a second road user.

According to at least one disclosed embodiment, the detection unit is a radar sensor installed in the central console.

According to a further disclosed embodiment, the apparatus has a GPS unit and/or a camera for detecting the line of vision of the transportation vehicle occupant and/or a sensor for detecting the transportation vehicle surroundings.

An exemplary apparatus for receiving information that has been sent to a second road user by a first road user comprises a communication unit that receives a signal containing information about a gesture made by a first road user with his hand or at least one finger. An evaluation and control unit evaluates the received signal to determine whether the gesture made by the first road user has been directed by him at the receiving second road user. An output unit outputs information about the gesture made by the first road user to the second road user if the gesture has been directed at the receiving second road user.

The disclosed embodiments also relate to a transportation vehicle in which the disclosed method or the disclosed apparatus is used.

To provide a better understanding of the principles of the present disclosure, exemplary embodiments are explained in more detail below with reference to the figures. It goes without saying that the disclosure is not restricted to these exemplary embodiments and that the features described can also be combined or modified without departing from the scope of protection of the disclosure.

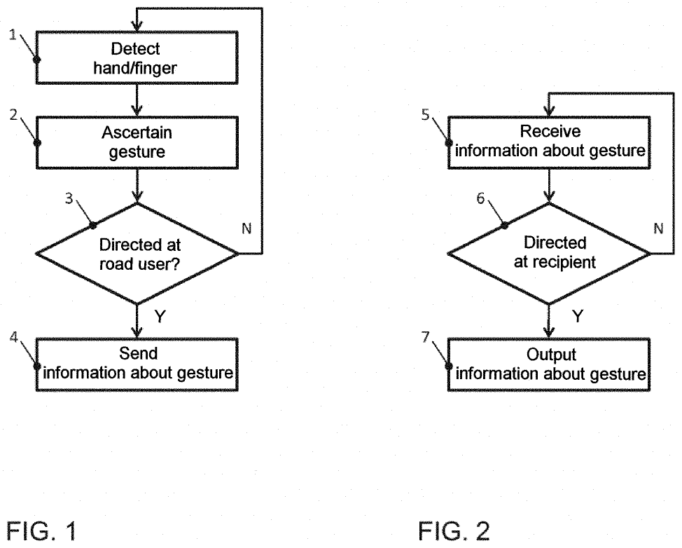

FIG. 1 schematically shows an exemplary embodiment of the disclosed method for sending information, which method can be used for gesture communication between two road users who are in separate transportation vehicles, for example, as drivers.

According to a first method operation at 1, this involves the hand or single figure of a road user being detected by sensor. If the road user makes a gesture with his hand or single fingers, this is ascertained in method operation at 2. The ascertained gesture is then evaluated in a method operation at 3 to determine whether it is directed at a second road user or else is supposed to be used, for example, to control a transportation vehicle functionality, such as, for example, an infotainment system, instead. This can be accomplished by a comparison with various stored gestures, for example. If the ascertained gesture then corresponds to a stored gesture typical of a gesture communication with another road user, it can be assumed that such a gesture communication is also supposed to take place in the present case. Instead or additionally, the line of vision of the road user can also be detected. If this establishes that the road user looks in the direction of another road user while making the gesture, this can also serve as an indication that a gesture communication with this road user is desired. This can be accomplished by using environment sensors to establish whether there is another road user in the line of vision.

If the result of the evaluation is that the gesture is directed at another road user, then a method operation at 4 involves a signal containing information about the ascertained gesture being sent to the second road user by the first road user. The information in this instance can also contain a direction and/or position statement. As such, the current absolute position of the first road user, ascertained from GPS data, and the direction in which the first road user makes the gesture and/or looks while making the gesture can be transmitted. At the receiving end, the second road user can then ascertain from this direction and position statement, together with the current absolute position of the second road user, the direction from which there is an intention to communicate.

A disclosed method as shown in FIG. 2 is performed for the second road user. In a method operation at 5, the signal containing the information about the gesture made by the first road user is first of all received. In method operation at 6, a check is then performed, for example, on the basis of the transmitted direction and/or position statement, to determine whether the gesture made by the first road user has been directed by him at the receiving second road user. If this is the case, a method operation at 7 involves information about the gesture being output at the second road user. This can be effected by a visual display on a display, for example. Instead or in addition, an audible reproduction via a loudspeaker can take place.

In the manner described above, it is thus possible for drivers of two transportation vehicles to communicate among one another, even in unclear or confusing traffic situations, before visual contact is possible or has been made.

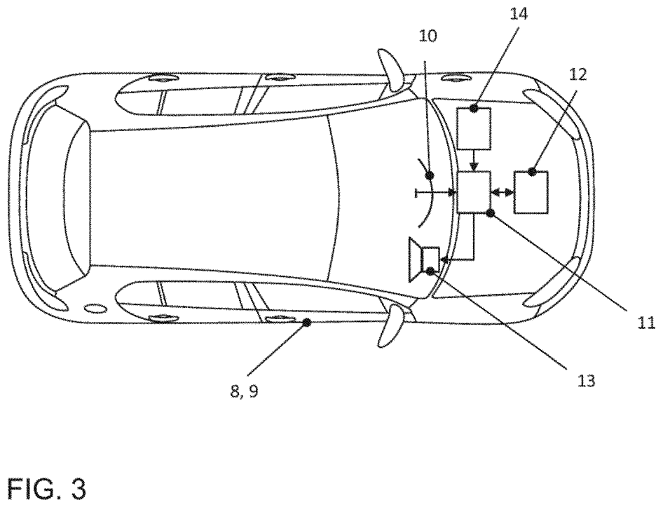

FIG. 3 schematically shows a transportation vehicle with a block diagram of an exemplary embodiment of an exemplary apparatus. The transportation vehicle in this instance can be an ego transportation vehicle 8 in which a first road user makes a gesture, or else another transportation vehicle 9 in which a second road user receives the gesture information.

To detect the hand or fingers of a transportation vehicle occupant, in particular, the driver, there is provision for a detection unit 10. This can be a radar sensor, in particular. The radar sensor in this instance involves transmitting a radar wave and evaluating the echo. From the propagation delay of the radar wave and if need be the frequency difference of the returning radar wave on account of the Doppler effect, it is possible to ascertain both the distance and the speed of the reflecting hand or fingers in a spatially resolved state. The radar waves can transmit radar waves in a pulsed mode or else in a continuous wave mode in this case. In a pulsed mode, radar pulses that are separate from one another are transmitted, the pulses each having a duration in the microsecond range, for example. In the continuous wave mode, the radar signal may be frequency-modulated.

Instead of a radar sensor, it is also possible for a 3D camera to be used. This is possible when the line of vision of the transportation vehicle occupant is also supposed to be detected, since a joint 3D camera can then be used for detecting both the gesture and the line of vision. The 3D camera may then be operated in the near infrared range, since infrared lighting, not depicted, thus ensures operation even in darkness without the transportation vehicle occupant being disturbed or dazzled as a result.

The radar sensor and the 3D camera are installed in the interior such that the hand or fingers can be effectively detected during a gesture, for example, in areas of the central console, of the dashboard, of the rearview mirror or of the roof lining. This also allows what are known as micro gestures, which involve just small hand or finger movements taking place, to be detected.

When the transportation vehicle occupant makes a gesture, this is detected by the detection unit 10, which outputs data about the hand or finger positions to an evaluation and control unit 11. The evaluation and control unit, which can have a microprocessor, an internal electronic memory and one or more electrical interfaces, takes these data as a basis for ascertaining what gesture is made by the transportation vehicle occupant.

This can be accomplished by taking the radar or image signals and ascertaining features that are then compared with applicable stored patterns of hands or fingers making a gesture. If the evaluation and control unit 11 ascertains that a gesture has been directed at a second road user, then applicable information, possibly together with a direction and/or position statement, is forwarded to a communication unit 12. As such, a direction statement comprising the line of vision detection described above and the absolute position of the transportation vehicle are able to be ascertained by a GPS unit 14.

The communication unit 12 then uses wireless communication techniques, which may be envisaged for a vehicle-to-vehicle communication (Car2Car communication) or Car2X communication anyway, to transmit information about the gesture made and, possibly additionally, direction and/or position statements to a further road user. The transmitted information about the gesture made can comprise a symbol corresponding to the gesture, for example. Similarly, it is alternatively possible, in the event of standardization for the gesture communication, for the transmitter end to follow detection of the gesture by looking up and transmitting a data word corresponding to the gesture, for example, in a lookup table. At the receiving end, a corresponding lookup table is then used to check the gesture to which the received data word corresponds, so as then to output information for this gesture. In addition to the information about the gesture made and the direction and/or position statements, a unique identification address and possibly further information about the respective road user or the transportation vehicle used by him can also be transmitted and evaluated at the receiving end. By way of example, this can allow, in addition to the information about the gesture, more precise statements pertaining to the ego transportation vehicle, such as, for example, the manufacturer of the transportation vehicle or the color or the name of the transportation vehicle keeper, to be output so as to facilitate identification of the transportation vehicle from which a gesture has been transmitted.

The interchange of information and data can take place directly between the road users involved, for example, by WLAN, or alternatively via a central server that communicates with the individual road users. In a system having a central server, the server can have data pertaining to the current position of the road user, or alternatively a unique identification address and possibly further information about the respective road user or the transportation vehicle used by him, which can be transmitted to the other road user. Furthermore, a server system can have provision for the features of the hand or fingers that have been ascertained from the radar or image signals to be transmitted to the server and for detection of the gesture to be performed only then.

In the transportation vehicle of the second road user, the transmitted signal is received by a communication unit 12 and evaluated by an evaluation and control unit 11. If this reveals, for example, from the transmitted direction and/or position statements, that a gesture has been directed at him by a first road user, then an output unit 13 outputs advice of the intention to communicate or information or a warning directly. As such, a voice output can be provided via one or more loudspeakers and/or via a display, for example, a head up display. This can involve the head up display being used to show a symbol corresponding to the gesture or an appropriate text. This may be shown on the front window such that it is perceived in proximity to the first road user who made the gesture.

Furthermore, one or more environment sensors, not depicted, which can be installed at various locations on the transportation vehicle bodywork, can be used to detect other road users in the transportation vehicle surroundings. This can involve, for example, camera sensors, radar or ultrasonic sensors or a combination of multiple sensors using different sensor technology being used.

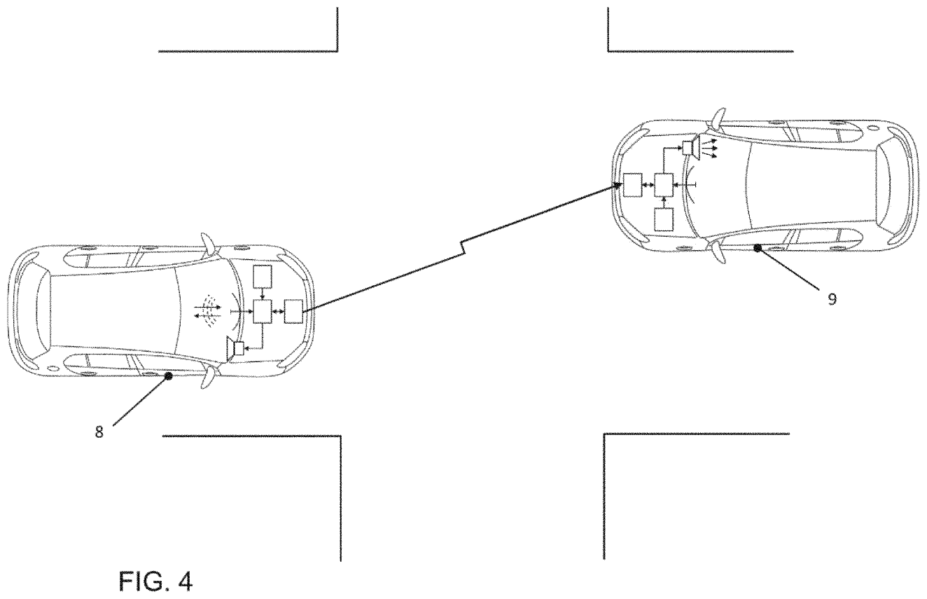

FIG. 4 shows an example of a traffic situation in which the disclosed method can be used. In this case, there is a first road user in an ego transportation vehicle 8 and a second road user in another transportation vehicle 9, the two of whom are facing one another at a junction and each want to turn left. Owing to the narrow road width assumed in the example, it is not possible to turn at the same time safely, however, which means that the two road users need to agree who turns first. If the first road user in the ego transportation vehicle 8 then uses a hand gesture to indicate to the second road user in the other transportation vehicle 9 that he is waiting and his opposite number can turn first, the gesture is detected and corresponding gesture information is transmitted from the communication unit of the ego transportation vehicle 8 to the communication unit of the other transportation vehicle 9. The second road user in the other transportation vehicle 9 is then provided with appropriate information, for example, by virtue of a voice output “the driver opposite is permitting you to turn first”. Even if the second road user in the other transportation vehicle 9 should not have immediately seen the gesture directed at him, he is in this way then nevertheless aware that he can turn safely.

The disclosed method is not restricted to yielding, but rather can be applied to a large number of gestures. As such, for example, the second road user can use a gesture to thank the first road user for yielding.

Similarly, a first road user can use a gesture to greet a second road user or ask him to stop together at the next opportunity or to take the next exit together on the road currently being used. Similarly, a telephone gesture can be used to express the desire to speak to one another on the telephone, provision also being able to be made for the telephone number of the first road user to be transmitted to the second road user together with the information about the telephone gesture. If the second road user also wants to speak on the telephone, the transmitted telephone number may then be able to be dialed directly.

Further examples of conveying information to other transportation vehicles can be warnings that other road users want to send to a specific driver, such as, for example: “Caution: there has been an accident over there—drive carefully.”, or “Attention: your brake lights are not working.”

By contrast, gestures that can be regarded as provocative or insulting are not transmitted to a second road user.

The disclosed embodiments can be used for any road users where there are the technical prerequisites for gesture detection and evaluation and information conveyance and reproduction. As such, the disclosed embodiments can admittedly be implemented particularly effectively in transportation vehicles such as automobiles, trucks and motorcycles for use by the respective transportation vehicle driver. However, it is also possible, by way of example, to transmit information about the gesture of a transportation vehicle driver to a cyclist or pedestrian equipped with a mobile telephone that, as a result of an application program installed on the telephone, is capable of performing the receiving-end method. The information can then be output, for example, on the display of the mobile telephone or by headphones. Similarly, it is possible for not only a gesture by the transportation vehicle driver in a transportation vehicle but also a gesture by other transportation vehicle occupants, such as, for example, the front-seat passenger, to be detected. The disclosed embodiments can also be used when the second road user is in a transportation vehicle that is not being driven by him manually, but rather is in an autonomous driving mode. Finally, use in rail, air and shipping traffic is also conceivable.

### LIST OF REFERENCE SIGNS

1 Detect hand/finger
2 Ascertain gesture
3 Evaluate gesture
4 Send information about gesture
5 Receive signal containing information about gesture
6 Evaluate signal
7 Output information about gesture
8 Ego transportation vehicle
9 Other transportation vehicle
10 Detection unit
11 Evaluation and control unit
12 Communication unit
13 Output unit
14 GPS unit

1. A method for sending information for a gesture communication between two road users, wherein a first road user is in an ego transportation vehicle and a second road user is in another transportation vehicle in the vehicle surroundings of the ego transportation vehicle, the method comprising:
detecting the hand or at least one finger of the first road user in the ego transportation vehicle by sensor;
ascertaining a gesture that the first road user makes in the ego transportation vehicle with his hand or at least one finger;
evaluating the ascertained gesture to determine whether the ascertained gesture is a gesture for gesture communication and is directed at a second road user in another transportation vehicle; and
sending a signal containing information about the ascertained gesture for gesture communication to the second road user by the first road user in response to the ascertained gesture being directed at a second road user in another transportation vehicle.

2. A method for receiving information for a gesture communication that has been sent from a first road user to a second road user, wherein the first road user is in an ego transportation vehicle and the second road user is in another transportation vehicle in the vehicle surroundings of the ego transportation vehicle, the method comprising:
receiving by a second road user a signal transmitted by a first road user, wherein the transmitted signal contains information about a gesture made by the first road user with his hand or at least one finger for gesture communication;
evaluating the received signal to determine whether the gesture made by the first road user has been directed by him at the receiving second road user; and
outputting information about the gesture made by the first road user to the second road user in response to the gesture being directed at the receiving second road user.

3. The method of claim 1, wherein evaluating the ascertained gesture comprises:
making a comparison with stored gestures typical of a gesture communication with another road user; and/or
detecting the line of vision of the first road user and performing a check to determine whether the first road user looks in the direction of another road user while making the gesture.

4. The method of claim 3, further comprising the ego transportation vehicle ascertaining a direction and/or position statement and transmitting the direction and/or position statement to the other transportation vehicle.

5. The method of claim 4, wherein the other transportation vehicle ascertains from the transmitted direction and/or position statement whether the gesture has been directed at the second road user by the first road user.

6. The method of claim 4, wherein the direction statement is ascertained by detecting the line of vision of the vehicle occupant of the ego transportation vehicle.

7. The method of claim 4, wherein the position statement is ascertained from a GPS signal received by the ego transportation vehicle.

8. An apparatus for sending information for a gesture communication between two road users, wherein the first road user is in an ego transportation vehicle and the second road user is in another transportation vehicle in the vehicle surroundings of the ego transportation vehicle, the apparatus comprising:
a detection unit that detects the hand or at least one finger of a first road user by sensor;
an evaluation and control unit to which data are supplied by the detection unit and that
takes the data of the detection unit as a basis for ascertaining a gesture that the first road user makes in the ego transportation vehicle with his hand or at least one finger;
evaluates the ascertained gesture to determine whether the ascertained gesture is a gesture for gesture communication and has been directed at a second road user in another transportation vehicle; and
a communication unit to which information about the ascertained gesture is supplied by the evaluation and control unit in response to the ascertained gesture being directed at a second road user for gesture communication, and that sends a signal containing information about the ascertained gesture to an apparatus in another transportation vehicle of a second road user.

9. The apparatus of claim 8, wherein the detection unit is a radar sensor installed in the central console.

10. The apparatus of claim 8, further comprising a GPS unit and/or a camera for detecting the line of vision of the transportation vehicle occupant and/or a sensor for detecting the transportation vehicle surroundings.

11. An apparatus for receiving information for a gesture communication that has been sent to a second road user by a first road user, wherein the first road user is in an ego transportation vehicle and the second road user is in another transportation vehicle in the vehicle surroundings of the ego transportation vehicle, the apparatus comprising:
a communication unit that receives a signal containing information about a gesture for gesture communication that is made by a first road user with his hand or at least one finger;
an evaluation and control unit that evaluates the received signal to determine whether the gesture made by the first road user has been directed by him at the receiving second road user; and
an output unit that outputs information about the gesture made by the first road user to the second road user in response to the gesture being directed at the receiving second road user.

12. A motor transportation vehicle configured to carry out a method for sending information for gesture communication between two road users, wherein a first road user is in an ego transportation vehicle and a second road user is in another transportation vehicle in the vehicle surroundings of the ego transportation vehicle, the transportation vehicle comprising the apparatus of claim 8.

13. The apparatus of claim 8, wherein the evaluation the ascertained gesture comprises:
making a comparison with stored gestures typical of a gesture communication with another road user; and/or
detecting the line of vision of the first road user and performing a check to determine whether the first road user looks in the direction of another road user while making the gesture.

14. The apparatus of claim 13, wherein the ego transportation vehicle additionally ascertains a direction and/or position statement and transmits the direction and/or position statement to the other transportation vehicle.

15. The apparatus of claim 14, wherein the other transportation vehicle ascertains from the transmitted direction and/or position statement whether the gesture has been directed at the second road user by the first road user.

16. The apparatus of claim 14, wherein the direction statement is ascertained by detecting the line of vision of the vehicle occupant of the ego transportation vehicle.

17. The apparatus of claim 14, wherein the position statement is ascertained from a GPS signal received by the ego transportation vehicle.

18. A transportation vehicle configured to carry out a method for receiving information for a gesture communication that has been sent from a first road user to a second road user, wherein the first road user is in an ego transportation vehicle and the second road user is in another transportation vehicle in the vehicle surroundings of the ego transportation vehicle, wherein the transportation vehicle comprises the apparatus of claim 11.
